(19) United States
(12) Patent Application Publication
(10) Pub. No.: US 2025/0230926 A1
(43) Pub. Date: Jul. 17, 2025

(54) PLUG CONNECTOR OF A LIGHT SOURCE, THE LIGHT SOURCE AND LIGHTING DEVICE WITH THE PLUG CONNECTOR

(71) Applicant: LEDVANCE GmbH, Garching bei München (DE)

(72) Inventors: Armin KONRAD, Großaitingen (DE); Henrike STREPPEL, Regensburg (DE); Ralph HOECK, Friedberg (DE); Shijun NIE, Garching (DE); Zhian LI, Shenzhen Guangdong (CN); Shaoping CHEN, Shenzhen Guangdong (CN)

(21) Appl. No.: 19/008,765

(22) Filed: Jan. 3, 2025

(30) Foreign Application Priority Data
Jan. 12, 2024 (DE) 102024100981.0

(51) Int. Cl. F21V 23/06; H01R 12/70; H01R 12/72

(52) U.S. Cl. CPC F21V 23/06; H01R 12/7005; H01R 12/7088; H01R 12/721

(57) ABSTRACT

A plug connector for connecting to a connection device of a light source is provided. The plug connector includes: (1) a first connection for connecting the plug connector to a power supply; (2) a first contact element electrically connected to the first connection for providing an electrical connection to at least one contact point of at least one power supply line of the light source; (3) a second connection for connecting the plug connector to an earthing line; and (4) a second contact element electrically connected to the second connection for providing an electrical connection to at least one contact point of at least one earthing line of the light source, so that, when the plug connector is connected to the connection device, both a power supply and earthing of the light source can be achieved. Furthermore, a light source and lighting device are provided.

### CROSS-REFERENCE TO RELATED APPLICATIONS

This patent application claims the benefit of and priority to German Patent Application No. 102024100981.0, filed on Jan. 12, 2024, which is herein incorporated by reference in its entirety.

### FIELD OF THE DISCLOSURE

The technical field of the present disclosure relates generally to plug connectors. In particular, the present disclosure relates to a plug connector of a light source, the light source, and a lighting device with the plug connector.

### BACKGROUND

Lighting devices with light sources and plug connections for supplying power to the light sources are known. The light sources can take the form of so-called alternators or light engines, which can be connected to a power supply by means of plug connections, for example. Some lighting devices or light engines require earthing, which can be realized, in particular, by an additional cable or an additional plug connection. The provision of earthing requires additional effort, which is associated with increased material requirements and higher costs.

### SUMMARY

It is an object of the present application to provide a simple and cost-effective way of earthing a light source.

According to a first aspect, a plug connector for connecting to a connection device of a light source is provided for solving this object. The plug connector comprises at least one first connection for connecting the plug connector to a power supply and at least one first contact element electrically connected to the at least one first connection for providing an electrical connection to at least one contact point of at least one power supply line of the light source. The plug connector further comprises at least one second connection for connecting the plug connector to an earthing line or to earth potential and at least one second contact element electrically connected to the at least one second connection for providing an electrical connection to at least one contact point of at least one earthing line of the light source, so that when the plug connector is connected to the connection device of the light source, both a power supply and earthing of the light source can be achieved.

By connecting the plug connector to the connection device of the light source, the light source can be supplied with power and earthed or connected to earth potential. In particular, the plug connector defines a safe light engine interface that enables simple earthing of the light source or lighting device. Due to the earthing contact integrated in the plug connector, the plug connector enables the light source to be safely installed or replaced, in particular without additional equipment or additional installation work.

The plug connector can be designed to be connected to a printed circuit board of the light source, so that the at least one first contact element can be electrically connected to at least one first contact point or contact pad of the printed circuit board. In particular, the plug connector can be designed to accommodate an area of the printed circuit board designed as a connection device. Through the possibility of accommodating the printed circuit board of the light source in the plug connector, the power supply and earthing of the light source can be provided in a particularly simple manner, in particular without a special plug on the part of the light engine.

In particular, the plug connector can be designed so that the at least one second contact element can be electrically connected to at least one second contact point of the printed circuit board. In particular, the at least one second contact point of the printed circuit board can be designed as a contact pad of the printed circuit board. As a result, the power supply and earthing can be carried out in a simple manner via a connection area of the printed circuit board.

In some embodiments, at least one second contact element is formed for electrically contacting an electrically conductive holding element of the light source. In particular, at least one second contact point can be formed by the electrically conductive holding element. The holding element can thus also be used as an earthing lead, which can simplify the layout of the printed circuit board of the light source.

In particular, the plug connector can be designed to accommodate an electrically conductive holding element of the light source, so that the electrical connection to at least one second contact point can be made by the electrically conductive holding element of the light source. Light sources held by holding rails can therefore be easily earthed during installation.

The plug connector can be designed to accommodate at least one second contact point that is spatially offset along a plug direction with respect to at least one first contact point. In particular, the second contact point can be spatially offset in such a way that when the light source is connected to the plug connector, the second contact point is contacted first by a second contact element of the plug connector and only then the first contact point is contacted by a second contact element. The spatial offset of the contact points can thus ensure that the light source is already earthed before it is connected to the power source, which enables the light source to be mounted safely.

According to a second aspect, a light source is proposed. The light source comprises at least one connection device for connecting the light source to a plug connector according to the first aspect. The at least one connection device comprises at least one first contact point for providing an electrical connection to the at least one first contact element of the plug connector and at least one second contact point for providing an electrical connection to the at least one second contact element of the plug connector. The light source can be connected to a power supply and to an earthing line in a simple and safe manner by the plug connector.

The light source can comprise at least one printed circuit board, wherein the at least one connection device of the light source can be at least partially formed by the at least one printed circuit board. By forming the printed circuit board as a connection device, the plug connection between the light source and the plug connector can be realized without a special plug on the part of the light source.

The at least one connection device of the light source has at least one second contact point that is spatially offset along a plug-in direction with respect to at least one first contact point. In particular, the spatial offset of the contacts can ensure that the light source is already earthed before it is connected to the power source, which enables the light source to be mounted safely.

According to a third aspect, a lighting device is provided. The lighting device comprises at least one light source according to the second aspect and at least one plug connector according to the first aspect for connecting the light source to a power source and to an earthing line. The lighting device has a simple structure and can be provided at particularly low cost. In addition, the light source of the lighting device can be mounted or replaced in a particularly safe and simple manner.

The invention will now be explained in more detail with reference to the attached figures. The same reference symbols are used in the figures for identical or similarly acting parts.

### BRIEF DESCRIPTION OF THE DRAWINGS

FIG. 1 shows a detailed perspective view of a lighting device according to an example embodiment,

FIG. 2 shows a detailed perspective view of a lighting device according to another example embodiment,

FIG. 3 shows a further perspective detail view of a lighting device according to FIG. 1, and

FIG. 4 shows a detailed perspective view of a lighting device according to a further example embodiment.

### DETAILED DESCRIPTION

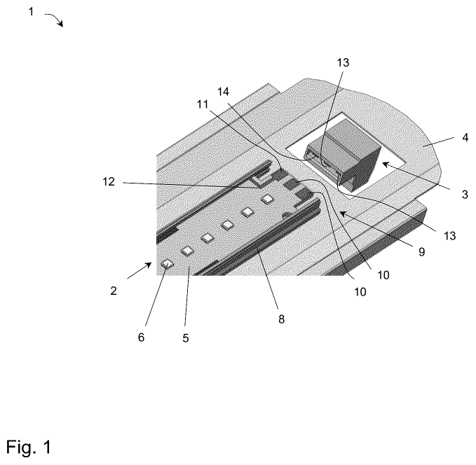

FIG. 1 shows a detailed perspective view of a lighting device 1 according to an example embodiment. In the example embodiment shown, the lighting device 1 is elongated, wherein an end region of the lighting device 1 is shown in the detailed view of FIG. 1.

The lighting device 1 comprises a light source 2 according to the second aspect and a plug connector 3 according to the first aspect. The lighting device 1 further comprises a housing or housing element 4 on which the light source 2 is mounted. In particular, the housing element 4 can function as a mounting element for mounting the light engine. To illustrate the structure of the lighting device 1, the light source 2 and the plug connector 3 are shown in a separate state.

The light source 2 is in the form of an elongated LED light engine. The LED light engine comprises a printed circuit board 5 on which a number of LEDs 6 are mounted. The printed circuit board 5 is mounted on the housing element 4 by a holding rail 8. The end of the light source 2 visible in FIG. 1 has a connection device 9 with first contact points 10 or contact pads and with a second contact point 11 or contact pad.

The first contact points 10 are connected to electrical lines or electrical circuits (not shown) of the light engine to supply power to the LEDs 6. The electrical circuit of the light engine comprises an earthing line 12 or earthing passage, which is electrically connected to the second contact point 11 and to the holding rail 8. The earthing line 12 or ground bushing is located near the end of the printed circuit board 5, which reduces the length of the earthing line 12 and the cost of the printed circuit board 5.

The holding rail 8 and the housing element 4 can be at least partially electrically conductive, so that the earthing line 12 can be electrically connected to the housing element 4 of the lighting device 1 via the holding rail 8.

The plug connector 3 comprises first contact elements 13 and a second contact element 14. The first contact elements 13 are designed to contact the first contact points 10 of the printed circuit board 5, and the second contact element 14 is designed to contact the second contact point 11 of the printed circuit board 5. The plug connector 3 also comprises electrical connections for connecting the plug connector 3 to a power supply and to an earthing line 12. The connections of the plug connector 3 are not visible in the illustration in FIG. 1.

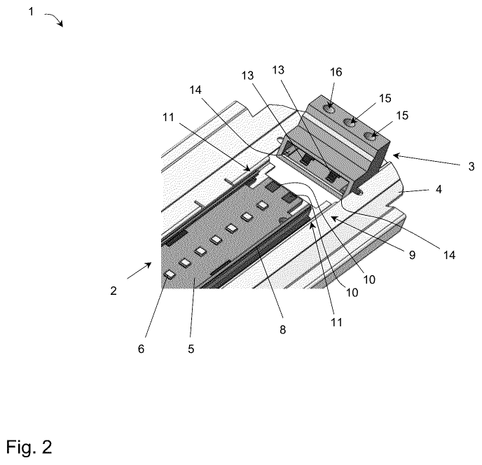

FIG. 2 shows a detailed perspective view of a lighting device 1 according to another example embodiment. The example embodiment of FIG. 2 essentially corresponds to the example embodiment of FIG. 1, wherein one end region of the holding rail 8 is designed as second contact points 11.

The illustration in FIG. 2 also shows the first connections 15 and the second connection 16 of the plug connector 3. The connections are designed to accommodate wire contacts or contact pins for connecting the plug connector 3 to a power source or to an earthing line 12.

The first contact elements 13 are designed to contact the first contact points 10, and the second contact elements 14 are designed to contact the second contact points 11 in the end area of the holding rail 8.

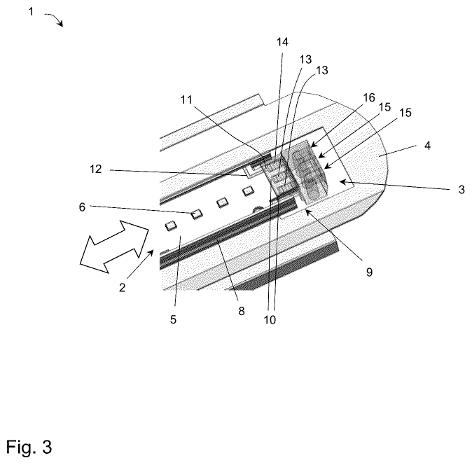

FIG. 3 shows a further perspective detail view of a lighting device 1 according to FIG. 1. In the illustration in FIG. 3, the light source 2 is connected to the plug connector 3. To clarify the structure, the interface between the light source 2 and the plug connector 3 is shown as semi-transparent.

The wide double arrow illustrates the translational movement of the light source 2 and the plug connector 3 in relation to each other required to form or release the plug connection between the light source 2 and the plug connector 3.

In the connected or installed state of the light source 2, the first contact elements 13 of the plug connector 3 are connected to the first contact points 10 of the printed circuit board 5, and the second contact element 14 is connected to the second contact point 11 of the printed circuit board 5.

The first connections 15 of the plug connector 3 are, thus, electrically connected to the power supply lines of the light engine by the first contact elements 13 and the first contact points 10. The first connections 15 or the power connections of the plug connector 3 are, thus, electrically connected to the power supply lines of the light engine via the first contact elements 13 and the first contact points 10.

The second connection 16 of the plug connector 3 is connected to the earthing line 12 of the printed circuit board 5 by the second contact element 14 and the second contact point 11. The earthing line 12 is connected to the housing element 4 via the holding rail 8, so that an electrical connection is created between the second connection 16 or the earth connection and the housing element 4 of the lighting device 1.

By connecting the plug connector 3 to the light source 2, the light engine and the lighting device 1 can be earthed, and the light engine can be supplied with power at the same time.

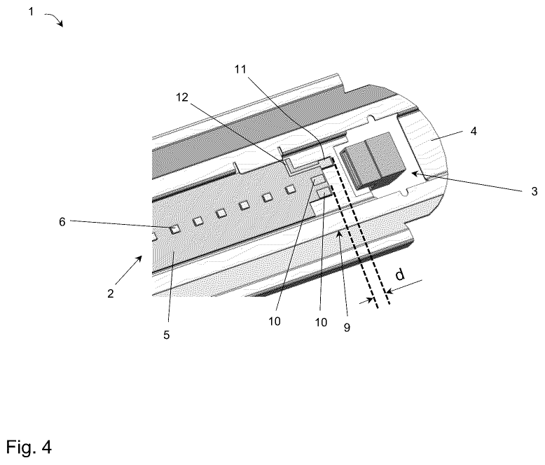

FIG. 4 shows a detailed perspective view of a lighting device 1 according to a further example embodiment. The example embodiment of FIG. 4 essentially corresponds to the example embodiment of FIG. 1, but differs in the area of the connection device 9 at the end of the printed circuit board 5. The second contact point 11 is spatially offset by a length d with respect to the first contact points 10 along the longitudinal direction of the light engine or plug direction. The length d of the spatial offset essentially corresponds to the length of the contact points 10, 11 or the size of the contact pads. The spatial offset of the contact points 10 and 11 ensures that, when the light source 2 is connected to the plug connector 3, the second contact point 11 is first electrically connected to earth or earth potential and only then is the light engine supplied with power. When removing the light source 2 from the lighting device 1, the spatial offset of the contact points 10 and 11 ensures that the earthing is disconnected later than the power supply to the light source 2. The light source 2 therefore can be installed or replaced in a particularly safe manner.

Thus, an interface for contacting a light source 2 or light engine is proposed, which enables simple and safe mounting of the light source 2. In some embodiments, the light source 2 and/or the lighting device 1 has a cooling system. The connection device 9 for connecting to a plug connector 3 can be located at one end or at two or more points of the light source 2.

The earthing line 12 or the earthing passage is firmly connected to the conductive parts of the light source 2 or lighting device 1 and to earth via the plug connector 3, which is connected to the power source and to the earthing line 12. Alternatively, or additionally, a conductive part of the light source 2 can act as an earthing passage and be connected directly to earth via the plug connector 3 (see holding rail 8 of the example embodiment according to FIG. 2).

The interface enables safe replacement and tool-free electrical connection of the light source 2 or light engine. The earthing and the high-voltage input are essentially connected or disconnected simultaneously or in quick succession during replacement (see the example in FIG. 4). This ensures, in particular, that the user or installation personnel always have to deal with the earthed light source 2, regardless of whether the lighting device 1 has failed or not.

To summarize, it can be said that the interface proposed here enables the light sources 2 to be replaced quickly and safely and electrically connected without tools. For a lighting device 1 with such an interface or connector, there is also no need for an additional earth connection, which means that a user-friendly and reliable connection can be realized with reduced material and process costs.

Although at least one exemplary embodiment has been shown in the foregoing description, various changes and modifications may be made. Said embodiments are merely examples and are not intended to limit the scope, applicability or configuration of the present disclosure in any way. Rather, the foregoing description provides the skilled person with a plan for implementing at least one exemplary embodiment, wherein numerous changes in the function and arrangement of elements described in an exemplary embodiment may be made without departing from the scope of protection of the appended claims and their legal equivalents. Furthermore, according to the principles described herein, several modules or several products can also be combined with each other in order to obtain further functions.

### LIST OF REFERENCE SYMBOLS

1 lighting device
2 light source
3 plug connector
4 housing element
5 printed circuit board
6 LED
8 holding element/rail
9 connection device
10 first contact point(s)
11 second contact point(s)
12 earthing line
13 first contact element
14 second contact element
15 first connection
16 second connection
d length of spatial offset

What is claimed is:

1. A plug connector configured for connection to a connection device of a light source, the plug connector comprising:
at least one first connection configured for connecting the plug connector to a power supply;
at least one first contact element electrically connected to the at least one first connection and configured for providing an electrical connection to at least one contact point of at least one power supply line of the light source;
at least one second connection configured for connecting the plug connector to an earthing line; and
at least one second contact element electrically connected to the at least one second connection and configured for providing an electrical connection to at least one contact point of at least one earthing line of the light source, so that, when the plug connector is connected to the connection device of the light source, both energizing and earthing of the light source are achievable.

2. The plug connector according to claim 1, wherein the plug connector is configured to be connected to a printed circuit board of the light source, so that the at least one first contact element is electrically connectable to at least one first contact point of the printed circuit board.

3. The plug connector according to claim 2, wherein the plug connector is configured such that the at least one second contact element is electrically connectable to at least one second contact point of the printed circuit board.

4. The plug connector according to claim 1, wherein the at least one second contact element is formed for electrically contacting an electrically conductive holding rail of the light source.

5. The plug connector according to claim 4, wherein the plug connector is configured to receive the electrically conductive holding rail of the light source, so that electrical connection to the at least one second contact point is able to be made by the holding rail of the light source.

6. The plug connector according to claim 1, wherein the plug connector is configured to receive at least one second contact point spatially offset along a plug direction with respect to at least one first contact point.

7. A light source comprising at least one connection device configured for connection to the plug connector according to claim 1, wherein the at least one connection device comprises:
at least one first contact point configured for providing an electrical connection to the at least one first contact element of the plug connector; and
at least one second contact point configured for providing an electrical connection to the at least one second contact element of the plug connector.

8. The light source according to claim 7, further comprising at least one printed circuit board, wherein the at least one connection device of the light source is at least partially formed by the at least one printed circuit board.

9. The light source according to claim 7, wherein the at least one second contact point is spatially offset along a plug direction with respect to the at least one first contact point.

10. A lighting device comprising the plug connector according to claim 1.

11. The lighting device according to claim 10, further comprising the light source.
